(19) United States
(12) Patent Application Publication
(10) Pub. No.: US 2006/0246329 A1
(43) Pub. Date: Nov. 2, 2006

(54) Systems and methods for adaptive energy management in a fuel cell system

(76) Inventors: Ravi B. Gopal, Oakville (CA); Robert C. Del Core, Etobicoke (CA)

Correspondence Address: BERESKIN AND PARR, 40 KING STREET WEST, BOX 401, TORONTO, ON, M5H 3Y2, CA

(21) Appl. No.: 11/412,132

(22) Filed: Apr. 27, 2006

Related U.S. Application Data
(60) Provisional application No. 60/675,083, filed on Apr. 27, 2005.

(51) Int. Cl. H01M 8/24; H02J 7/00

(52) U.S. Cl. 429/18; 320/101

(57) ABSTRACT

An electrochemical cell system has a fuel cell power module and an electric energy storage module. The system further has an adaptive energy management controller connected to the fuel cell power module and the electric energy storage module for regulation of operation of the fuel cell power module. The adaptive energy management controller has a measurement device for measuring a process parameter indicative of the power or current drawn by the load or the current requested by the load. The controller further has a calculation and storage device for calculating and storing a time average value indicative of the power drawn over a first pre-set time period. The stored average value is used as an actual current draw request set-point signal by the adaptive energy management controller for regulating the operation of the fuel cell power module for a second time period following the first time period. The time average is a moving time average, a mean value or an endpoint-to-endpoint average. The system further has a control unit for regulation of the fuel cell stack and the balance-of-plant unit. The adaptive energy management controller may incorporate the control unit.

### PRIORITY CLAIM

A priority claim is made to U.S.. Provisional Application No. 60/675083 (filed on Apr. 27, 2005) and the entire contents of which are hereby incorporated by reference.

### The section headings used herein are for organizational purposes only and are not to be construed as limiting the claims in any way.

### FIELD OF THE INVENTION

The invention relates to fuel cell systems, and, in particular to systems and methods for adaptive energy management in a fuel cell system.

### BACKGROUND OF THE INVENTION

A fuel cell is a type of electrochemical device that produces electrical energy from the stored chemical energy of reactants according to a particular electrochemical process. One example of a particular type of fuel cell is a Proton Exchange Membrane (PEM) fuel cell that is operable to provide electrical energy to a load. Generally, a PEM fuel cell includes an anode, a cathode and a thin polymer membrane arranged between the anode and cathode. Hydrogen and an oxidant are supplied as reactants for a set of complementary electrochemical reactions that yield electricity, heat and water.

In practice, fuel cells are not typically operated as single units. Rather, a number of fuel cells are connected in series to form a fuel cell stack that is in turn included in a Fuel Cell Power Module (FCPM). The oxidant utilized in a fuel cell stack can be provided by oxygen carrying ambient air. In high-pressure fuel cell systems ambient air is forced through an air compressor to increase the rate and pressure at which oxygen is delivered to the cathodes in the fuel cell stack. However, air compressors typically require a relatively large energy input to be operable, which in turn reduces the overall efficiency of a fuel cell power module. On the other hand, low-pressure fuel cell systems have been developed that have relaxed input pressure requirements with respect to the oxidant input stream. However, a problem common to many low-pressure fuel cell systems is that such systems typically have a slow output transient response to abrupt and/or fast load variations.

In an attempt to provide a fuel cell system with a faster dynamic response, a fuel cell power module may be coupled with another power source exhibiting better transient behavior. Systems employing a combination of batteries and/or ultra-capacitors as temporary power sources have been previously introduced. In particular, a fuel cell system including a battery pack has been used in experimental fuel cell powered vehicles to extend the operative range of the vehicles, in addition to improving the transient response of the fuel cell system.

In operation the battery pack is charged by coupling output energy from the fuel cell stack using a charging system integrated into the fuel cell system. Typically, a charging system requires detailed real-time information about the battery pack State of Charge (SOC) and the Duty Cycle (DC) history of the system (i.e. what DC current has been drawn, also referred to as the drive cycle of the system). In order to obtain the information expensive and complicated instrumentation is added to a fuel cell system, which adds to both the weight and cost to the fuel cell system.

### SUMMARY OF THE INVENTION

According to an aspect of an embodiment of the invention there is provided an energy storage module interface (that can be part of an adaptive energy management controller) connectable between a fuel cell power module and an electric energy storage module for regulation of operation of the fuel cell power module, wherein the energy storage module is connectable, in use, to a load, and wherein the energy storage module comprises:

a measurement device for measuring a process parameter indicative of the power drawn by the load, and

a calculation and storage device for calculating and storing a time average value indicative of the power drawn over a first pre-set time period;

wherein the stored time average value is used as an actual current draw request set-point signal by the adaptive energy management controller for regulating the operation of the fuel cell power module for a second time period following the first time period.

In accordance with a second aspect of the present invention, there is provided a method of operating a fuel cell system comprising a fuel cell power module electrically connectable to an electric energy storage module, the method comprising the steps of:

a) connecting the fuel cell system to a load;

b) measuring a process parameter indicative of the power drawn by the load;

c) calculating and storing a time average value of the power drawn over a first pre-set time period;

d) using the stored average value as an actual current draw request set-point signal to the adaptive energy management controller for regulating the operation of the fuel cell power module for a following second time period; and

e) repeating step b) to d) at the end of the second time period.

In accordance with a further aspect of the present invention, there is provided an electrochemical cell system having a fuel cell power module and an electric energy storage module, the fuel cell power module comprising a fuel cell stack, a balance-of plant unit for controllably connecting the fuel cell stack in fluid communication with at least process fluid, an output of the fuel cell power module connectable to the electric energy storage module and an output of the electric energy storage module connectable to a load; the system further comprising:

an adaptive energy management controller connectable between the fuel cell power module and the electric energy storage module for regulating operation of the fuel cell power module, the adaptive energy management controller comprising

a measurement device for measuring a process parameter indicative of the power drawn by the load, and

a calculation and storage device for calculating and storing a time average value indicative of the power drawn over a first pre-set time period;

wherein the stored time average value is used as an actual current draw request set-point signal by the adaptive energy management controller for regulating the operation of the fuel cell power module for a second time period following the first time period.

Other aspects and features of the present invention will become apparent, to those ordinarily skilled in the art, upon review of the following description of the specific embodiments of the invention.

### BRIEF DESCRIPTION OF THE DRAWINGS

For a better understanding of the present invention, and to show more clearly how it may be carried into effect, reference will now be made, by way of example, to the accompanying drawings, which illustrate aspects of embodiments of the present invention and in which:

FIG. 1 is a simplified schematic drawing of a fuel cell module;

FIG. 1a is a diagram of a logic schematic used to generate data for FIGS. 2-6;

FIG. 1b is a diagram of a logic schematic used to generate data for FIGS. 7-12;

FIG. 2 is a schematic drawing of a fuel cell system having adaptive current control according to an embodiment of the invention;

FIG. 3 is an example set of graphs showing simulation results for discharge voltage, discharge current and State of Charge (SOC) during a pure electrical discharge of a first battery pack;

FIG. 4 is a first example set of extended time graphs showing simulations test results for discharge voltage, discharge current, SOC and a Fuel Cell Power Module (FCPM) enable signal;

FIG. 5 is a second example set of extended time graphs showing simulations test results for discharge voltage, discharge current, SOC and a FCPM enable signal;

FIG. 6 is a third example set of extended time graphs showing simulations test results for discharge voltage, discharge current, SOC and a FCPM enable signal;

FIG. 7 is a first set of extended time graphs showing simulations test results for discharge voltage, discharge current, SOC and a FCPM enable/charge signal in accordance with aspects of the invention;

FIG. 8 is a second set of extended time graphs showing simulations test results for discharge voltage, discharge current, SOC and a FCPM enable/charge signal in accordance with aspects of the invention;

FIG. 9 is a third set of extended time graphs showing simulations test results for discharge voltage, discharge current, SOC and a FCPM enable/charge signal in accordance with aspects of the invention;

FIG. 10 is a fourth set of extended time graphs showing simulations test results for discharge voltage, discharge current, SOC and a FCPM enable/charge signal in accordance with aspects of the invention;

FIG. 11 is a fifth set of extended time graphs showing simulations test results for discharge voltage, discharge current, SOC and a FCPM enable/charge signal in accordance with aspects of the invention; and

FIG. 12 is a sixth set of extended time graphs showing simulations test results for discharge voltage, discharge current, SOC and a FCPM enable/charge signal in accordance with aspects of the invention.

### DETAILED DESCRIPTION OF THE INVENTION

A fuel cell stack is typically made up of a number of singular fuel cells connected in series. The fuel cell stack is included in a fuel cell module, otherwise known as a Fuel Cell Power Module (FCPM), that includes a suitable combination of supporting elements, collectively termed a balance-of-plant system, which are specifically configured to maintain operating parameters and functions for the fuel cell stack in steady state operation. Exemplary functions of a balance-of-plant system include the maintenance and regulation of various pressures, temperatures and flow rates. Accordingly those skilled in the art will understand that a fuel cell module also includes a suitable combination of associated structural elements, mechanical systems, hardware, firmware and software that is employed to support the function and operation of the fuel cell module. Such items include, without limitation, piping, sensors, regulators, current collectors, seals, insulators and electromechanical controllers. Hereinafter only those items relating to aspects specific to the present invention will be described.

There are a number of different fuel cell technologies and, in general, this invention is expected to be applicable to all types of fuel cells. Very specific example embodiments of the invention have been developed for use with Proton Exchange Membrane (PEM) fuel cells. Other types of fuel cells include, without limitation, Alkaline Fuel Cells (AFC), Direct Methanol Fuel Cells (DMFC), Molten Carbonate Fuel Cells (MCFC), Phosphoric Acid Fuel Cells (PAFC), Solid Oxide Fuel Cells (SOFC) and Regenerative Fuel Cells (RFC).

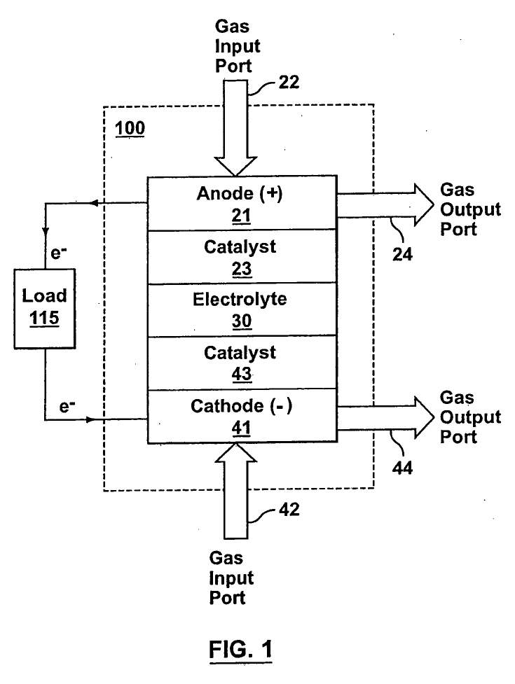

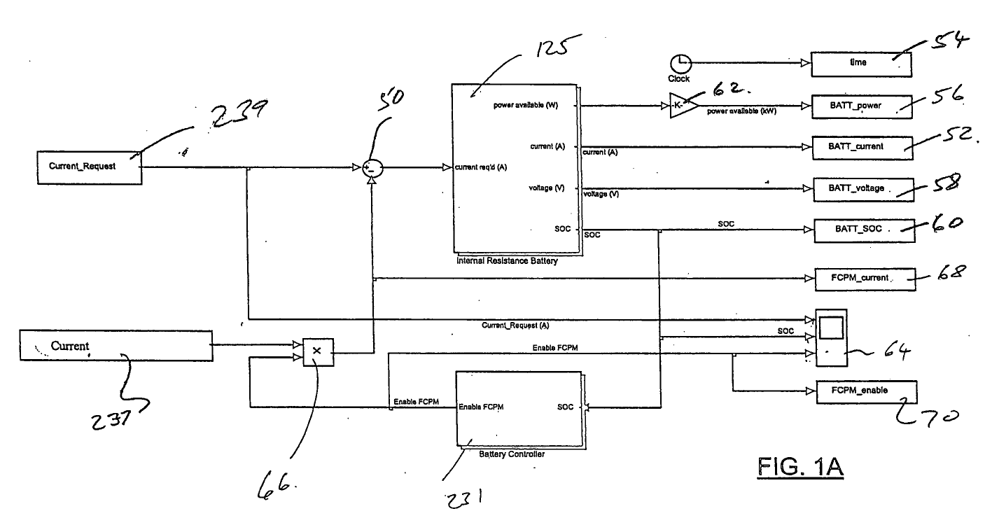

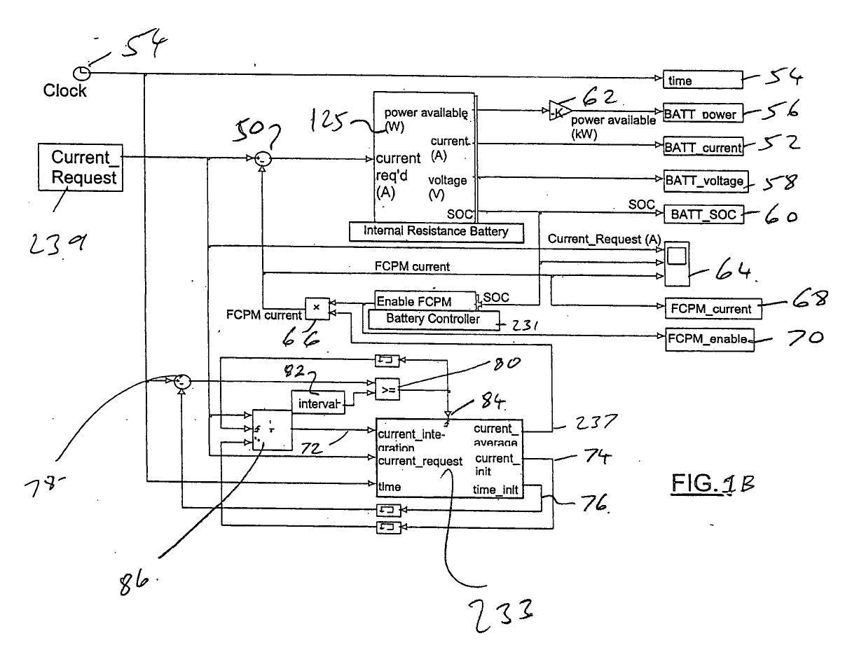

Referring to FIG. 1, shown is a simplified schematic graph of a Proton Exchange Membrane (PEM) fuel cell module, simply referred to as fuel cell module 100 hereinafter, that is described herein to illustrate some general considerations relating to the operation of electrochemical cell modules. It is to be understood that the present invention is applicable to various configurations of fuel cell modules that include one or more fuel cells.

The fuel cell module 100 includes an anode electrode 21 and a cathode electrode 41. The anode electrode 21 includes a gas input port 22 and a gas output port 24. Similarly, the cathode electrode 41 includes a gas input port 42 and a gas output port 44. An electrolyte membrane 30 is arranged between the anode electrode 21 and the cathode electrode 41.

The fuel cell module 100 also includes a first catalyst layer 23 between the anode electrode 21 and the electrolyte membrane 30, and a second catalyst layer 43 between the cathode electrode 41 and the electrolyte membrane 30. In some embodiments the first and second catalyst layers 23, 43 are directly deposited on the anode and cathode electrodes 21, 41, respectively.

A load 115 is connectable between the anode electrode 21 and the cathode electrode 41.

In operation, hydrogen fuel is introduced into the anode electrode 21 via the gas input port 22 under some predetermined conditions. Examples of the predetermined conditions include, without limitation, factors such as flow rate, temperature, pressure, relative humidity and a mixture of the hydrogen with other gases. The hydrogen reacts electrochemically according to reaction (1), given below, in the presence of the electrolyte membrane 30 and the first catalyst layer 23.
H₂→2H⁺+2e⁻ (1)
The chemical products of reaction (1) are hydrogen ions (i.e. cations) and electrons. The hydrogen ions pass through the electrolyte membrane 30 to the cathode electrode 41 while the electrons are drawn through the load 115. Excess hydrogen (sometimes in combination with other gases and/or fluids) is drawn out through the gas output port 24.

Simultaneously an oxidant, such as oxygen in the ambient air, is introduced into the cathode electrode 41 via the gas input port 42 under some predetermined conditions. Examples of the predetermined conditions include, without limitation, factors such as flow rate, temperature, pressure, relative humidity and a mixture of the oxidant with other gases. The excess gases, including the excess oxidant and the generated water are drawn out of the cathode electrode 41 through the gas output port 44. As noted previously, in low-pressure fuel cell systems the oxygen is supplied via oxygen carrying ambient air that is urged into the fuel cell stack using air blowers (not shown).

The oxidant reacts electrochemically according to reaction (2), given below, in the presence of the electrolyte membrane 30 and the second catalyst layer 43.
½O₂+2H⁺+2e⁻→H₂O (2)

The chemical product of reaction (2) is water. The electrons and the ionized hydrogen atoms, produced by reaction (1) in the anode electrode 21, are electrochemically consumed in reaction (2) in the cathode electrode 41. The electrochemical reactions (1) and (2) are complementary to one another and show that for each oxygen molecule (O₂) that is electrochemically consumed two hydrogen molecules (H₂) are electrochemically consumed.

The rate and pressure at which the reactants, hydrogen and oxygen, are delivered into the fuel cell module 100 effects the rate at which the reactions (1) and (2) occur. The reaction rates are also affected by the current demand of the load 115. As the current demand of the load 115 increases the reactions rate for reactions (1) and (2) increases in an attempt to meet the current demand.

Increased reaction rates cannot be sustained unless the reactants are replenished at a rate that supports the consumption requirements of the fuel cell module 100. As noted above, fuel cell power generators (i.e. a fuel cell module employed to supply power to a load, as shown in FIG. 1) exhibit good steady-state performance but may perform less well in terms of dynamic response to abrupt changes in current demand from a load.

That is, fuel cells usually have an inherently limited load slew rate, which is adequate for some applications, but insufficient where close load following is desired. For example, commonly a blower is provided to supply air as the oxidant, and the speed of the blower is altered to vary the rate of air supply. However, the blower has a certain inertia, and its speed cannot be altered instantaneously; typically, the blower needs a few seconds to increase its speed and this will depend on the size of the blower which in turn is related to the size of the fuel cell power module. Other types of fuels cells may have other characteristics preventing rapid response. An example of where the inherent lack of dynamic response, of a typical fuel cell module, has proven to be insufficient is within a standalone AC power generation system in which the fuel cell module does not, or cannot possibly, receive a priori knowledge of current demand changes by the load.

In an attempt to provide a fuel cell system with a faster dynamic response, a fuel cell module may be coupled with another power source exhibiting better transient behavior, such as batteries. Another option is the use of ultra-capacitors instead of batteries. An ultra-capacitor is suitable for storing and rapidly releasing a current burst with high power density. In particular, in accordance with some embodiments of the present invention high-current and high-capacity ultra-capacitors can advantageously be combined with PEM fuel cell modules to provide a fuel cell system having a relatively fast dynamic response.

Another device may be employed to maintain an approximate lower bound for the SOC for either batteries and/or ultra-capacitors during operation of a FCPM. According to some embodiments of the present invention a battery pack interface is provided to adaptively control and maintain the state of charge in an energy storage module.

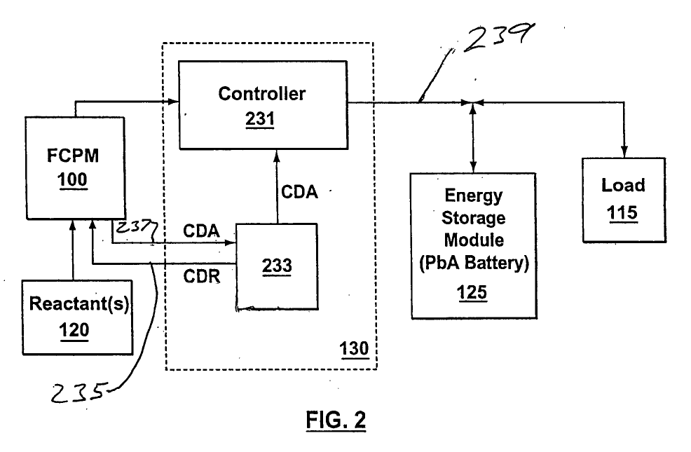

Referring to FIG. 1a there is shown a logic schematic used to develop simulation results of FIGS. 26. Here, for convenience, like reference numerals are used as described below in relation to FIG. 2. Thus, a battery, as an energy storage module is indicated at 125, and a controller is indicated at 231, forming part of an Adaptive Energy Management Controller 130. A current draw allowed signal, from the FCPM 100, is indicated at 237, and a total current requested is indicated at 239. Thus, the total current requested 239, the current demanded by the load 115, is connected to a subtraction unit 50. As detailed below, this also receives a signal indicative of the current supplied by the FCPM 100, so that the difference is the current required and drawn from the battery 125. As indicated at 52, the net current drawn from a battery is calculated.

Additional signals include a time signal at 54, a battery power indication signal 56, a battery voltage signal 58 and a battery state of charge (SOC) signal 60. The battery power signal 56 is supplied from a multiplier or gain unit 62 that converts the power available to kilowatts.

In FIG. 1a, block 125 indicates a simulation of the battery 125, and the state of charge 60 is calculated dependent upon the current drawn from the battery 125.

This state of charge signal is also connected to the battery controller and is used in accordance with the selected algorithm, to set an enable FCPM signal. It is here noted that this enable FCPM signal, together with the state of charge signal 60 and the total current requested 239 are connected to some sort of output display or the like indicated at 64.

The enable FCPM signal is connected to a multiplier unit 66, which is also connected to the signal 237 for the current draw allowed, so that the multiplier 66 then only, in effect, transmits the current draw allowed signal 237 onwards when the enable FCPM signal is set. This current signal is sent to the subtraction unit 50, as noted above, and also to an output 68 for the FCPM current. A further output 70 is also provided for the FCPM enable signal.

FIG. 2 is a schematic drawing of an extended fuel cell system including an energy storage module interface provided in accordance with aspects of the invention. Specifically, the extended fuel cell system includes the fuel cell module 100 (illustrated in FIG. 1), labeled FCPM 100 in FIG. 2. The extended fuel cell system also includes some basic features found in a practical fuel cell testing system. Those skilled in the art will appreciate that a practical testing system also includes a suitable combination of sensors, regulators (e.g. for temperature, pressure, humidity and flow rate control), control lines and supporting apparatus/instrumentation in addition to a suitable combination of hardware, software and firmware. Moreover, while this extended fuel cell system is configured for a PEM-type fuel cell, the sensors, regulators, etc. may need to be varied for other types of fuel cells.

The extended fuel cell system also includes a reactants module 120, the Adaptive Energy Management Controller 130, and the energy storage module 125, and is shown connected to the load 115, by way of example only. The reactants module 120 is provided to store hydrogen and/or oxidant for the FCPM 100. The energy storage module 125 may be a battery pack including lead acid batteries or other suitable battery types and/or ultra-capacitors. The current draw allowed signal (CDA) 237 is shown in FIG. 2, and in addition, there is shown a current draw requested (CDR) signal 235. Depending on the state of the FCPM, the CDA 237 may be less than the CDR 235, e.g. if cells of the FCPM 100 are damaged or are performing below normal levels.

The Adaptive Energy Management Controller 130 includes the controller 231 and an Energy Storage Module Interface (ESMI) 233, and is coupled between the FCPM 100 and the energy storage module 125, to facilitate the maintenance of a lower bound for the SOC of the energy storage module 125. In some embodiments the SOC control provided by the Adaptive Energy Management Controller 130 allows the use of cheap, proven and widely available lead acid battery technology. Lead acid batteries are typically not used in electric automotive applications since they are very sensitive to discharge depth and charge rate. In methods in accordance with aspects of the invention the rate of charge/discharge is managed within a narrow and range near the full capacity of the batteries and/or ultra-capacitors employed. In accordance with other aspects of the invention other battery types, for example Lithium ion batteries, may be used.

In some embodiments the control enabled by the ESMI 233 may also take additional energy sources, such as regenerative braking, into consideration. All that is required is changing the target set-point for the SOC, as will be described in detail further below. Moreover, no a priori knowledge of the duty cycle associated with-a battery and/or ultra-capacitor is required. Set-points may be tuned a priori by simulation if desired, but this is not necessary.

Furthermore, the FCPM life may be extended since the extended fuel cell system may be able to operate in a optimized steady state using the ESMI 233, without having to repeatedly cycle through severe power-up and power-down-up ramping.

The scope of the present invention include other energy storage devices: simulation data shows control methods in accordance with aspects of the invention may be applied to a FCPM in combination with ultra capacitors systems. The control strategy will allow maintaining a narrow swing on voltage limits from the ultra-capacitors. This is advantageous if reserve power is required for an application. If larger voltage swings are desired or allowable for an application, the control strategy takes this into consideration by setting the appropriate set-points on max and min voltages. The same control logic can be utilized independent of the energy storage medium. The control strategy may require knowledge of the battery chemistry used in order to determine optimal set-points for voltage and current limits (maximum and minimum). As discussed above, in order to maintain the desired state of charge, a control gain can be tuned to address efficiencies specific to each battery model and type.

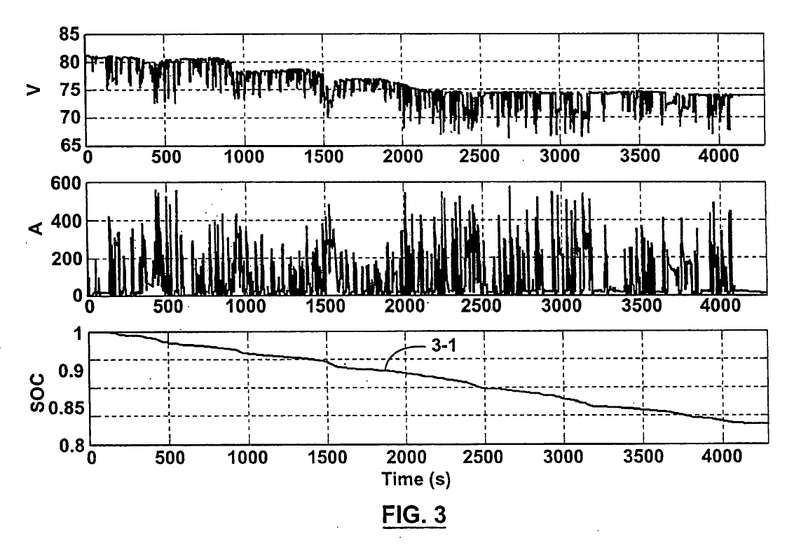

Referring to FIG. 3, and with continued reference to FIG. 2, there is shown an exemplary set of graphs showing simulation results for discharge voltage, discharge current and State of Charge (SOC) during a pure electrical discharge of a first battery pack having a 585 Ah (Ah, Ampere Hour) maximum capacity. That is, with reference to FIG. 2, the energy storage module 125 is a battery pack 125 having a 585 Ah capacity. The charge rate is correlated to historical average data (based on the duty cycle). The ampere-hours are counted and the FCPM 100 is turned off when the SOC is determined to be at a certain target value. Thus, the switching point is determined by a simple counting of the ampere-hours not by the use of hardware instrumentation that measures the SOC. Alternatively, instead of counting ampere-hours, the battery voltage may be monitored over time to predict the SOC. Both methods may be employed at the same time, and logically combined with an “and” or “or” relationship depending, for example, on the type of batteries used. This may well depend on the type of battery or other storage device used. For example lead acid batteries have a polarization curve that enables the SOC to be determined from the battery terminal voltage. Other battery types, e.g. NiMH, can show a flat characteristic so that voltage gives little indication of the state of charge; for NiMH other techniques may be possible, e.g. monitoring battery temperature. FIG. 3 shows the baseline case where there is a pure electric discharge over time with no recharging of the battery pack 125. The upper graph shows the output voltage as a function of elapsed time, the middle graph shows the drawn current as a function of elapsed time and the lower graph shows the SOC, generally indicated by 3-1, as a function of elapsed time.

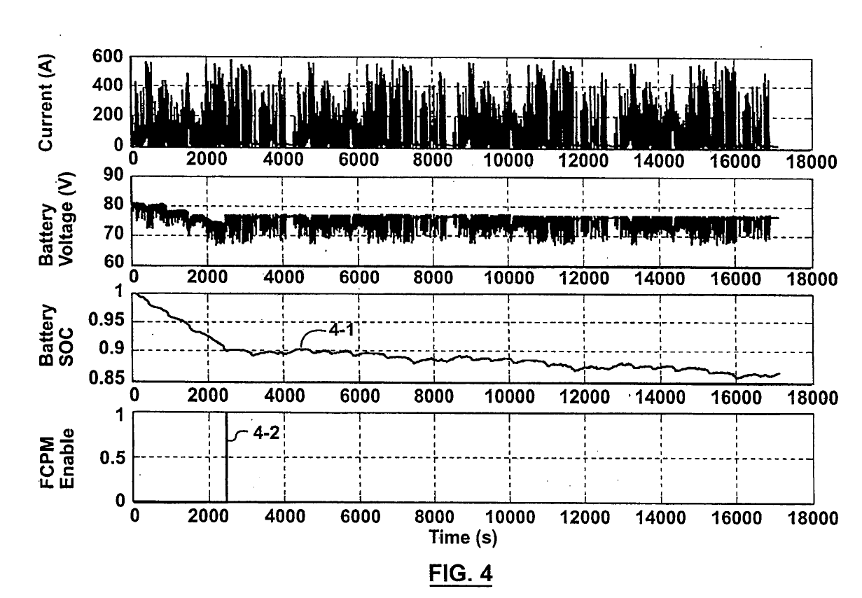

FIG. 4 is a first example set of extended time graphs showing simulation test results for discharge voltage, discharge current, SOC 4-1 and a Fuel Cell Power Module (FCPM) enable/charge signal 4-2. The FCPM enable/charge signal indicates the duty cycle for charging the battery pack 125. In the simulation corresponding to the data shown in FIG. 4, the 585 Ah battery pack 125 is running the same load profile as for FIG. 3, with the FCPM 100 charging the battery pack 125 at a specific time and at a charging current equal to 0.136 C (in this case 80 A), where 1.0 C represents the maximum capacity of the battery pack 125 expressed in Amps, i.e. 585 Amps here. The two upper graphs show the battery pack current and voltage as a function of elapsed time. The two lower graphs show the battery SOC 4-1 and the FCPM enable signal 4-2 as a function of elapsed time. The set point chosen for the FCPM enable signal 4-2 to start/stop charging the battery pack 125 is 0.9 SOC. In FIG. 4, the FCPM 100 is activated to charge the battery pack 125 at approximately 2500 seconds from start of the simulation run and remains in operation until the end of the simulation. The simulation results show that the SOC 4-1 cannot be maintained above the desired value of 0.9 using the charging current of the example (0.136 C) even with the FCPM 100 running continuously. This is likely due to system losses resulting from coulombic inefficiencies. In accordance with some aspects of the invention, described below, a gain parameter may be utilized to maintain the desired SOC level and overcome the coulombic inefficiencies.

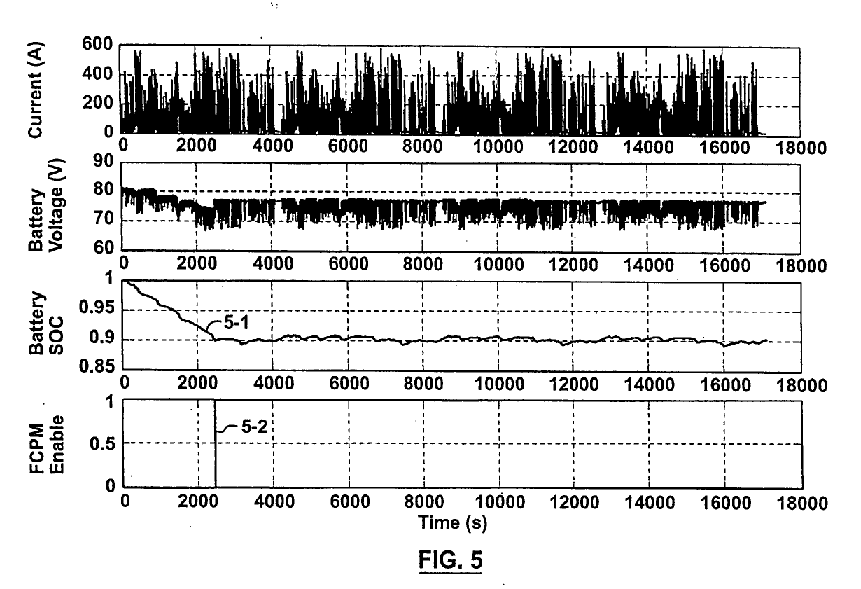

FIG. 5 is a second example set of extended time graphs showing simulations test results for discharge voltage, discharge current, SOC 5-1 and a FCPM enable signal 5-2. In this simulation the charging current is set to 0.146 C (85.4 A in this particular example). The result is that the SOC 5-1 is maintained at a higher level compared to what is the case in FIG. 4, and generally maintains the desired charge state of 0.9 C with some fluctuations due to varying power demands from the load. However, the SOC 5-1 can just be maintained above the desired value using the charging current of the example (0.146 C) with the drawback being that the FCPM enable signal 5-2, and thus the FCPM 100, has to be running continuously in an elevated state just to maintain the charge on the battery pack 125.

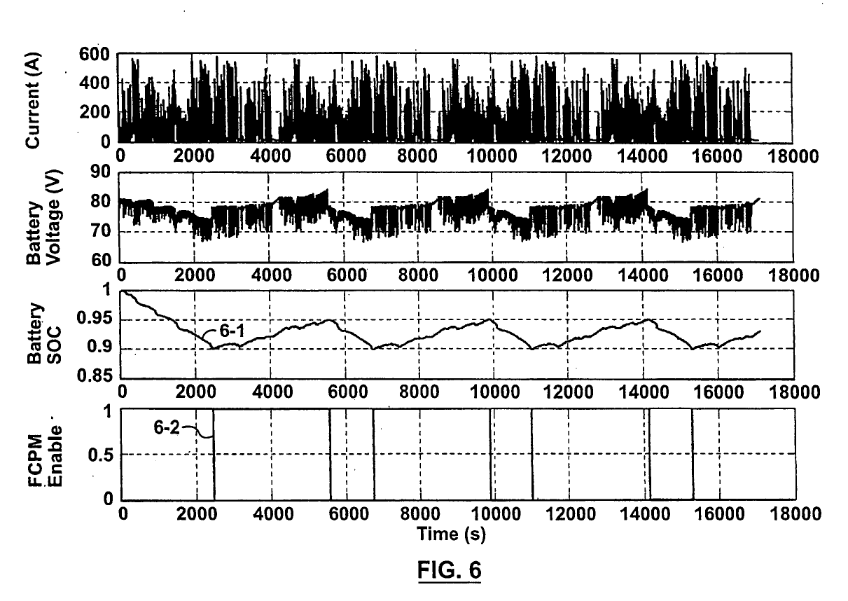

FIG. 6 is a third example set of extended time graphs showing simulations test results for discharge voltage, discharge current, a SOC 6-1 and a FCPM enable signal 6-2. In this simulation the charging current is set to 0.2 C (117 A in this particular example). The SOC 6-1 can then be maintained at a higher level compared to the simulation results shown in FIGS. 4 and 5. In fact, the SOC 6-1 approaches a near complete charge level and would do so if the FCPM enable signal 6-2, were not changed to signal a stop to the charging process. That is, the SOC 6-1 varies between a maximum value reached just before the FCPM enable signal 6-2 is switched to an off-state (at 0.95 C) and a minimum value reached just before the FCPM enable signal 6-2 is switched to the on-state (0.9 C). The range over which the SOC 6-1 varies can be defined by the maximum and minimum battery voltage values and may vary in different embodiments of the invention depending upon the battery type used and the application in which the battery system is used.

FIG. 6 also clearly shows the effect of turning the FCPM 100 on and off. When it is on, the battery voltage is higher and ramps upwards as the SOC approaches 0.95; with the FCPM turned off, the voltage drops and ramps down on the SOC ramps down to the 0.9 C value. In general, the higher the rate of charging, the more pronounced effect it will have on the voltage of the battery terminals. This is at least partially due to internal battery resistance. The voltage drop across this resistance will depend on the rate of charge, and this voltage drop adds to the voltage appearing at the battery terminals. Thus, setting the FCMP to charge at a high level, and then frequently turning it on and off, will give large voltage swings at the battery terminals. Other exemplary charge rates are 0.136 C, 0.25 C, 0.3 C, 0.4 C and 0.8 C, all determined by taking 1.0 C, representing the capacity of the battery, and expressing this in Amps.

Reference will now be made to FIG. 1b, which shows a variant of the schematic of FIG. 1a, including implementation of an adaptive energy management system or technique, for managing the charged state of the battery. For simplicity and brevity, like components in FIG. 1b are given the same reference as in FIG. 1a and the description of these components is not repeated.

In essence, in FIG. 1b, there is additionally shown the Energy Storage Module Interface (ESMI) 233.

This energy storage module interface 233 has an input for the time signal 54 and for the current requested or drawn 239. It also has an input 72 for current integration, as detailed below.

At its outputs, the energy storage module interface 233 has a current average output, that provides the current draw allowed signal 237, connected to the multiplier 66 and hence providing the enable signal for the FCPM 100. It also has an output 74 for a current initiation signal and an output 76 for a time period initiation signal 76. The time initiation signal 76 is connected to a subtractor 78, where it is subtracted from the current time, effectively to give an elapsed time from the initiation of the time period. This elapsed time is then fed to a unit 80 where it is compared with a set time interval provided from an interval unit 82. When the elapsed time is greater than the time interval supplied from the interval unit 82, then a signal is provided to a control input 84 of the energy storage module interface 233.

An integration unit 86 also receives this control signal, and further receives the current initiation signal 64 and the current requested or drawn. The integration unit 86 integrates the current with respect to time to give a measure of the total charge supplied, measured for example as amp hours. This signal is supplied as indicated at 72 to ESMI 233.

In use, the average current to be set for a period, with signal 237, is set depending upon the total charge, the integrated current signal 72, determined in the previous time period. Then, in the following or second time period, this average current is supplied, and simultaneously, the total current draw is again integrated with respect to time, to give a measure of the charge delivered during that second time period. Thus, continuously, the ESMI 233 adjusts the current delivered by the FCPM 100, during each time interval, and is dependent upon the previously current history or total charge supplied, to maintain the state of charge of the battery pack 125 at the desired level. If the state of charge exceeds the desired level, then the enable FCPM signal is not set.

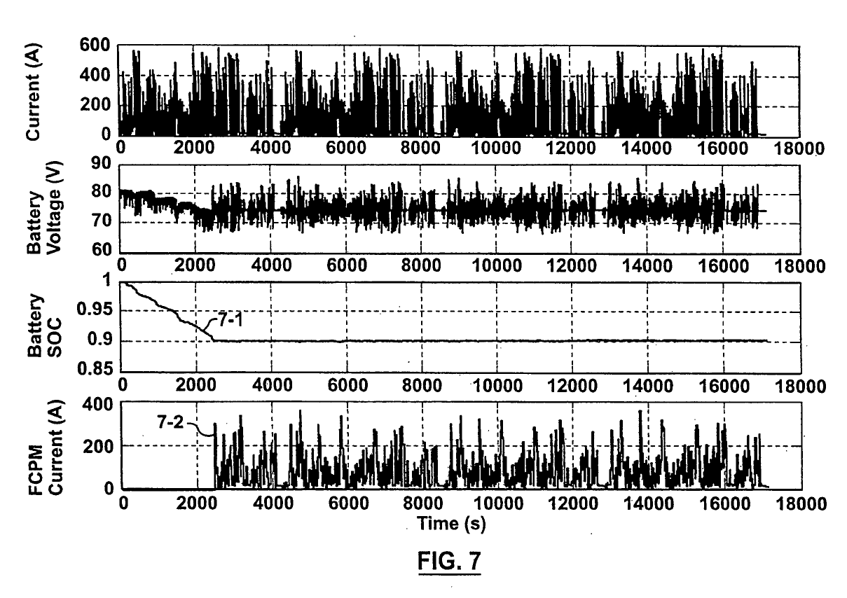

FIG. 7 is a first set of extended time graphs showing simulations test results for discharge voltage, discharge current, SOC 7-1 and a FCPM enable/charge signal 7-2 in accordance with aspects of the invention. More specifically, FIG. 7 shows simulation results according to aspects of an Adaptive Energy Management (AEM) system and method in accordance with aspects of the invention. More specifically, FIG. 7 shows the 585 Ah battery pack 125 driving the same load 115 as for FIGS. 3 to 6, with the FCPM 100 charging the battery pack 125 at a charging current equal to varying Current Draw Request (CDR) calculated as described below.

In accordance with some aspects of the invention the battery pack 125 was charged using an adaptive and varying current averaging charge procedure with a time averaging period that is applied to the FCPM enable/charge signal 7-2, which is set at a level in proportion to the charging current drawn from the FCPM 100 as opposed to being a simple binary on/off signal.

In accordance with some aspects of the invention a “moving” time average of the duty cycle is in the form of one of a measured current draw, a measured power draw, a current draw request or a power draw request. In accordance with some aspects of the invention a time average current draw is calculated and the averaged current over the selected time interval becomes the Current Draw Request (CDR) to a FCPM (e.g. FCPM 100). This can be effected in various ways. It can be: a true integral of the current with respect to time over the selected period; an average of a selected number of current data points taken during the time period; or an average of the endpoints, i.e. the currents at the endpoints of the time period. For some applications it may be possible to employ a moving window. In accordance with some aspects of the invention the time period of the moving average interval may impact the magnitude of the charge current. Determination of the level of a FCPM enable/charge signal in accordance with aspects of the invention is described below.

With specific reference to FIG. 7, the two upper graphs show the current draw and voltage as a function of elapsed time. The two lower graphs the battery SOC 7-1 and FCPM 7-2 as a function of elapsed time. FIG. 7 shows the results utilizing a time averaging period of 15 seconds, which was selected as an example only. Those skilled in the art will appreciate that the time averaging period may be adjusted/chosen to specifically suit a particular application, and other exemplary averaging periods are 30, 60, 120, 180, 300 and 600 seconds. The results indicate that the SOC 7-1 is maintained at almost a constant level (at approx. 0.9 C in this particular example) with very small fluctuations.

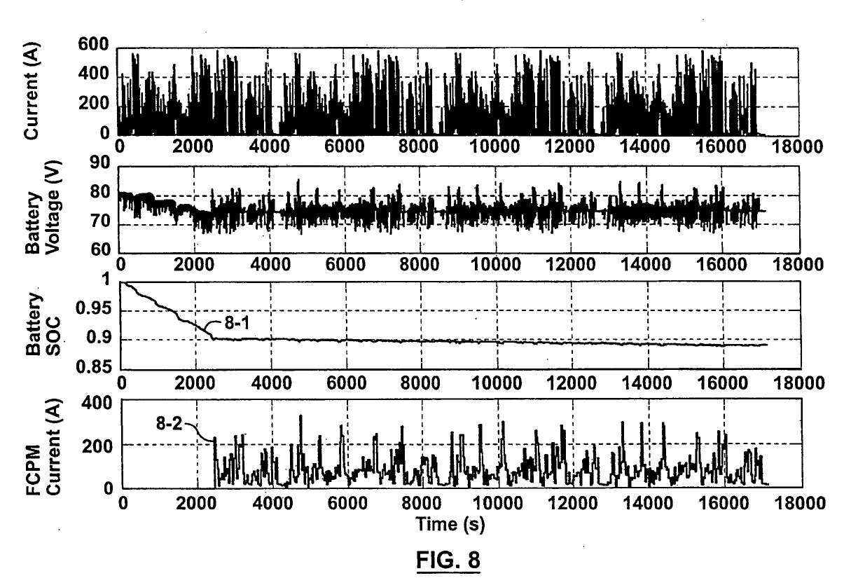

FIG. 8 is a second set of extended time graphs showing simulations test results for discharge voltage, discharge current, SOC 8-1 and a FCPM enable/charge signal 8-2 in accordance with aspects of the invention. More specifically, FIG. 8 shows graphs corresponding to those shown in FIG. 7, but utilizing a time averaging period of 30 seconds. The results shown in FIG. 8 indicate that SOC 8-1 slowly decreases over time using the time averaging period of 30 seconds. Generally, as the time averaging period increases beyond a threshold value (e.g. 15 seconds in this example shown in FIG. 7) the more likely it is that the SOC of a battery pack will fall below a predetermined lower bound (e.g. 0.90 C), as is the case in FIG. 8. In accordance with some aspects of the invention (as is described below) a gain factor can be introduced to compensate for this effect.

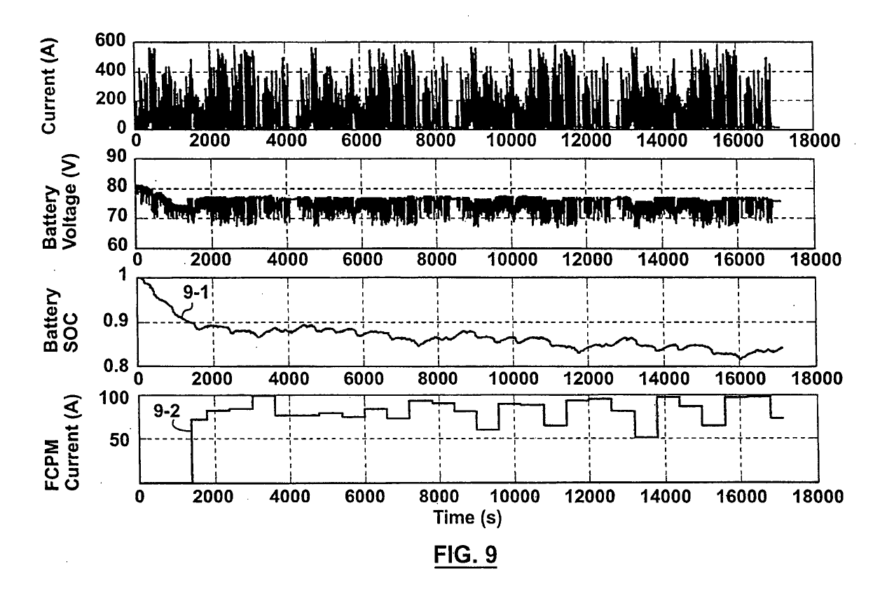

FIG. 9 is a third set of extended time graphs showing simulations test results for discharge voltage, discharge current, SOC 9-1 and a FCPM enable/charge signal 9-2 in accordance with aspects of the invention. More specifically, FIG. 9 shows graphs corresponding to those shown in FIGS. 7 and 8, but utilizing a time averaging period of 600 seconds. Following the trend established in results provided in FIG. 8 the SOC 9-1, while decreasing over time using this particular time averaging period, does show both a more rapid rate of decrease and also larger fluctuations due to the longer averaging period. All this occurs despite the variable operation of the FCPM 100 signaled by the variable FCPM enable/charge signal 902.

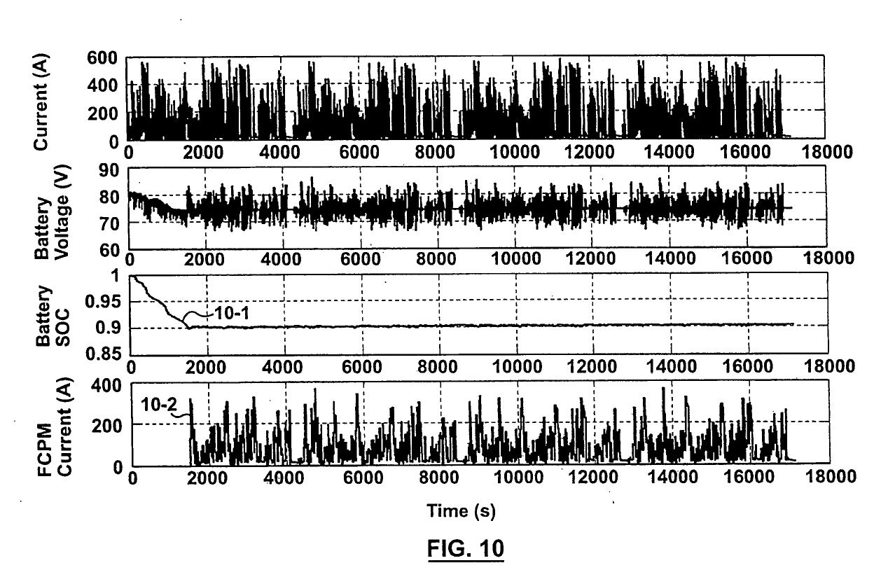

FIG. 10 is a fourth set of extended time graphs showing simulations test results for discharge voltage, discharge current, SOC 10-1 and a FCPM enable/charge signal 10-2 in accordance with aspects of the invention. With continued reference to FIG. 2, the simulation results obtained for FIG. 10 were obtained with a battery pack 125 having a 293 Ah maximum capacity and a second charging scheme in accordance with aspects of the invention using an adaptive current averaging charge procedure utilizing an time averaging period.

In accordance with some aspects of the invention a “moving” time average of the duty cycle is in the form of one of a measured current draw, a measured power draw, a current draw request or a power draw request. In accordance with some aspects of the invention a time average current draw is calculated and the averaged current over the selected time interval becomes the Current Draw Request (CDR) to a FCPM (e.g. FCPM 100). In accordance with some aspects of the invention the time period of the moving average interval may impact the magnitude of the charge current. Determination of the level of a FCPM enable/charge signal in accordance with aspects of the invention is described below.

With specific reference to FIG. 10, the two upper graphs show the current draw and voltage as a function of elapsed time. The two lower graphs show the SOC 10-1 and the FCPM enable/charge signal 10-2 as a function of elapsed time. The results were obtained utilizing a time averaging period of 15 seconds, similar to that for the results shown in FIG. 7. Again, as for the results shown in FIG. 7, the SOC 10-1 is maintained at approximately a constant level (at approx. 0.9 C in this particular example) with very small fluctuations.

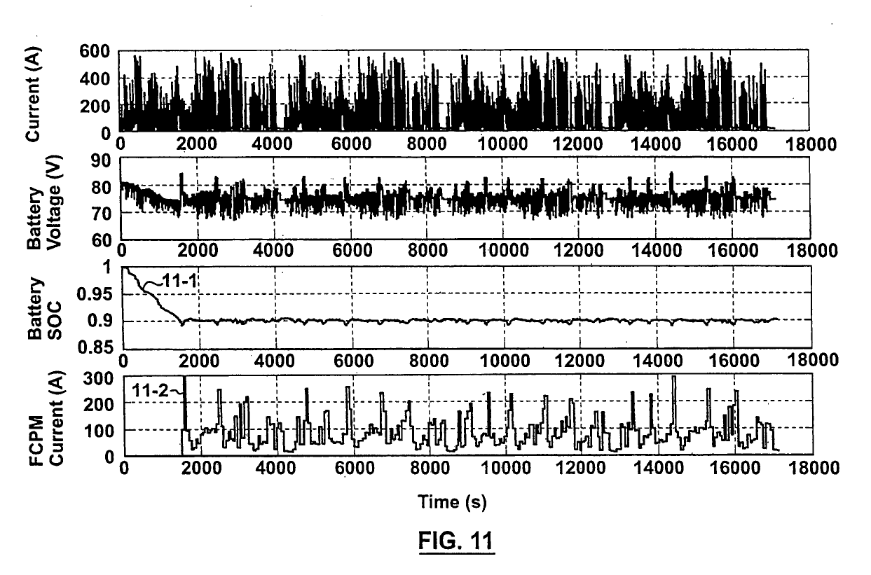

FIG. 11 is a fifth set of extended time graphs showing simulation test results for discharge voltage, discharge current, SOC 11-1 and a FCPM enable/charge signal 11-2 in accordance with aspects of the invention. FIG. 11 shows graphs corresponding to those shown in FIG. 10, but utilizing a time averaging period of 30 seconds. The results indicate that the SOC 11-1 is maintained at approximately a constant level (at approx. 0.9 C in this particular example) with fluctuations slightly larger than those shown in FIG. 10. In contrast to results shown in FIG. 8 (which show SOC 8-1 decreasing over time when the time averaging period is 30 seconds), the SOC 11-1 is maintained as a result of the addition of a current gain factor applied to the FCPM enable/charge signal 11-2. The determination of the current gain factor is described below.

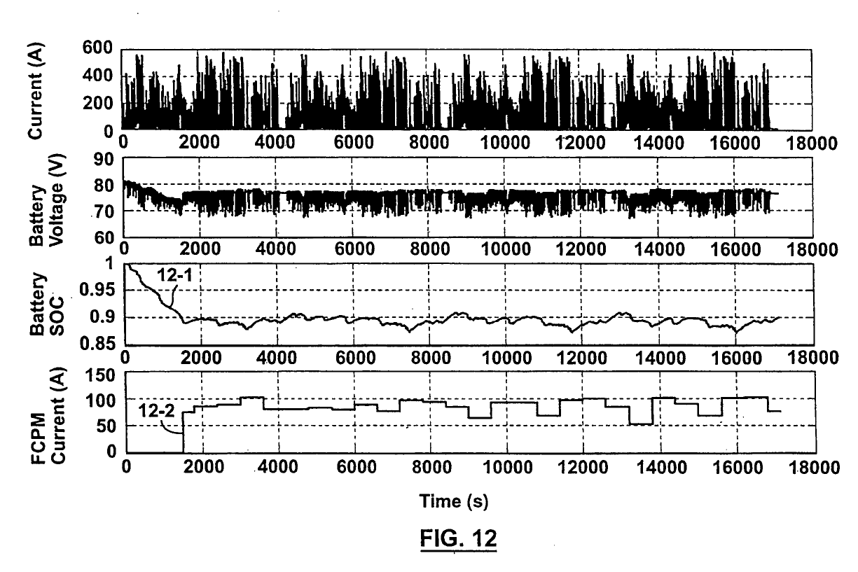

FIG. 12 is a sixth set of extended time graphs showing simulations test results for discharge voltage, discharge current, SOC 12-1 and a FCPM enable/charge signal 12-2 in accordance with aspects of the invention. FIG. 12 shows graphs corresponding to those shown in FIG. 10, but utilizing a time averaging period of 600 seconds. The results indicate that the SOC 12-2 is slowly decreasing over time using this particular time averaging period despite the application of a current gain factor.

As indicated for the simulation results presented, in accordance with some aspects of the invention, it is sometimes advantageous to employ a tunable/adjustable control parameter that can be applied to the FCPM enable/charge signal. In accordance with some aspects of the invention such a parameter may take the form of a current gain factor or gain parameter.

Moreover, in accordance with an Adaptive Energy Management control procedure, the current draw request (CDR) can be determined using the equation (3):
CDR=(Gain*Time_average_load_current) (3)
The Time_average_load_current is a time average over a typical time interval, for example 600 seconds.

The gain parameter, Gain, is estimated using equation (4):
Gain=ES_{—}V/FC_{—}V/C (4)
The term ES_V is the battery energy storage voltage at the desired target SOC to be maintained. The term FC_V is the FCPM voltage at maximum current density (typically approx. 0.8 A/cm²). The term C is the minimum value of the averaged battery coulombic efficiency and averaged power electronics efficiency.

An example calculation utilizing a 10 kW FCPM and NiCd Energy Storage (ES) battery module gives the following:

ES_V=77.82 V NiCd battery voltage at a SOC of 0.9

FC_V=40.28 V for a Hydrogenics HyPM 10 FCPM at 0.8 A cm2

C=min(0.9, 0.945)=0.9(average battery coulombic efficiency is 0.9, average boost converter efficiency (power electronics efficiency) is 0.945).

Thus, control Gain=77.82/40.28/0.9=2.1465.

While the above description provides example embodiments, it will be appreciated that the present invention is susceptible to modification and change without departing from the fair meaning and scope of the accompanying claims. Accordingly, what has been described is merely illustrative of the application of aspects of embodiments of the invention and numerous modifications and variations of the present invention are possible in light of the above teachings.

The present invention is based on the principle of recording or calculating power consumption from the battery or other energy storage device in one preceding time period, and then using this power consumption figure to determine electrical power to be generated by the FCPM 100 in a second, subsequent time period, to replenish the energy storage device. These time periods can be relatively long, compared to the time needed for the FCPM 100 to adjust to a new operating level, and during each period the FCPM 100 operates at a substantially constant level.

It is intended that the present invention will be particularly applicable to systems in which the majority of the power, even up to the maximum power, is generated by the energy storage module. For example, in an automotive type application, one might have an FCPM 100 with a 25 kilowatt capacity and an energy storage module 125 with a maximum rating of 100 kilowatts. (It will be understood that the maximum rating of an energy storage device can be a much less well defined quantity than the maximum rating of a fuel cell power unit. For example, ultracapacitors, for short periods of time, can deliver extremely high power levels; for many batteries, with high internal resistances, high power levels can be provided, if the losses in internal resistance and consequence heat generation can be tolerated.) In such a setup, it will be understood that the maximum power, with both the FCPM 100 and the battery or other energy storage module 125 running at maximum capacity would be 125 kilowatts. In a smaller vehicle, for example, one based on an electrically powered neighborhood vehicle, the FCPM 100 could be rated a 5 kilowatts, combined with a 30 kilowatt bank of ultracapacitors, providing the energy storage module 125.

Thus, it is envisaged that, in such a setup, for the large majority of the time, power would be supplied by the energy storage module 125, and the FCPM 100 would be run to maintain the energy storage module 125 at a substantially constant state of charge. At the same time, it would be recognized that, where maximum power is required (e.g. for sudden acceleration, hill climbing and the like), then one may need maximum current draw from the energy storage module 125 and the FCPM 100 operating at maximum capacity simultaneously.

Similarly, while it is intended that operation of the FCPM 100 in any given time period is based on the power preceding time period, for most applications, it will be desirable or necessary to provide some override type of function, in case operating conditions suddenly change. For example, as noted, if there is a sudden demand for a high power level, then, irrespective of the immediate past history of power drawn, the FCPM 100 should be switched to maximum operating level. Correspondingly, if a vehicle has been operated at a generally uniform power level and suddenly comes to a halt, then it may be necessary to shut down the FCPM 100 quickly, rather than continue to operate it at a power level determined by the immediate past operating history.

It is suggested that the FCPM 100 would be operated to maintain the energy storage module 125 at a desired SOC. Depending on the type of storage, it may be possible to monitor this SOC separately, since otherwise one has to rely on continuous integration or calculation of the power drawn from and power supplied to the energy storage module 125 to determine its current SOC. This SOC can be set depending on a number of characteristics, including the characteristics of the energy storage module and to what extent it can accept wide swings in the SOC.

For automotive and other applications, it will generally be desirable to have the SOC at a sufficiently low level that there is, in effect, storage room available in the energy storage module 125, for recovering energy from regenerative braking. Thus, at any time, desirably the difference between the set SOC and the maximum SOC is equivalent to the energy that could be recovered by regenerative braking from the maximum speed of the vehicle.

As to the selection of the length of the time periods, this will depend upon the characteristics of the individual components, and operating characteristics of the particular system. For example, if there are frequent and substantial fluctuations in the power demand, then it may be necessary to have relatively short time periods, so as to maintain the energy storage module in the desired state of charge. On the other hand, where there are large fluctuations in power demand, but these are of relatively short duration, then it may prove more beneficial to have a relatively long period, so as, in effect, within each period to effect some smoothing of these fluctuations. It is also possible that various techniques could be used to set the sampling rate, and the sampling rate could be varied so for example, a derivative could be taken of the power drawn from the energy storage module 125, and if this shows high levels, indicative of large and many fluctuations, then this could set shorter time periods.

In the case of automotive applications, this could enable the system, in effect, to adjust between different driving conditions. For example, in city driving, where there could be many and substantial fluctuations in power demand, relatively short time periods could be set. On the other hand, if the derivative technique mentioned above, or some other technique is used, this could detect when a vehicle is operating in highway conditions, at a substantially constant power level. Then, the time periods could be lengthened, while maintaining substantially the same state of charge. This would enable the FCPM 100 to be run at more constant conditions with fewer changes in operating conditions, and this in general will improve the efficiency of the FCPM 100.

A variety of different storage devices can be used, such as lead-acid, lithium ion and nickel metal hydride batteries, and as mentioned, ultracapacitors can be used as a non-battery storage medium. These and any other suitable storage devices can be used in combination, including two or more different types of device. Further the proportion of the total storage provided can be varied and need not be the same for each storage type used.

For the avoidance of doubt, it can be noted that a prior knowledge of the SOC is not necessary. The invention is based on the concept of supplying power from a storage module, and then ensuring that power supplied by the FCPM 100 matches this to maintain a uniform SOC. Where the power available from the storage module is greater than that from the FCPM 100 then this can be considered to be a “battery dominant” or “power module dominant” system.

We claim:

1. An energy storage module interface connectable between a fuel cell power module and an electric energy storage module for regulation of operation of the fuel cell power module, wherein the energy storage module is connectable, in use, to a load, and wherein the energy storage module comprises:
a measurement device for measuring a process parameter indicative of the power drawn by the load, and
a calculation and storage device for calculating and storing a time average value indicative of the power drawn over a first pre-set time period;
wherein the stored time average value is used as an actual current draw request set-point signal by the adaptive energy management controller for regulating the operation of the fuel cell power module for a second time period following the first time period.

2. An energy storage module as claimed in claim 1, wherein the process parameter measured by the measurement device is one of power drawn, power requested, current drawn and current requested by the load.

3. An energy storage module according to claim 1, wherein the time average value is selected from the group consisting of a moving time average, a mean value and an endpoint-to-endpoint average.

4. An energy storage module according to claim 3, further comprising a control unit for regulation of the fuel cell stack.

5. An energy storage module as claimed in claim 4, wherein the control unit includes a gain calculation device, for calculating a gain to be applied to current supplied by the fuel cell power module.

6. An energy storage module as claimed in claim 5, wherein the gain calculation device calculate a current draw request, for setting the current supplied by the fuel cell, according to:
Current Draw Request=Gain×Stored time average value wherein the Gain is calculated according to:
Gain=ES_V/FC_V/C
where ES_V is the voltage of the energy storage module at a desired target state of charge
FC_V is the voltage of the fuel cell power module at maximum current density, and
C is the minimum value of averaged coulombic inefficiency of the energy storage module and the averaged inefficiency of the power electronics.

7. An energy storage module as claimed in claim 1, wherein the first and second time periods are the same.

8. An energy storage module as claimed in claim 1, wherein the first and second time periods are different.

9. An energy storage module as claimed in claim 1, wherein the maximum power output of the fuel cell power module is less than the maximum power output of the energy storage module.

10. An energy storage module as claim in claim 9, wherein the energy storage module has a maximum power output that is in the range of 4 to 5 times the maximum power output of the fuel cell power module.

11. A method of operating a fuel cell system comprising a fuel cell power module electrically connectable to an electric energy storage module, the method comprising the steps of:
a) connecting the fuel cell system to a load;
b) measuring a process parameter indicative of the power drawn by the load;
c) calculating and storing a time average value of the power drawn over a first pre-set time period;
d) using the stored average value as an actual current draw request set-point signal to the adaptive energy management controller for regulating the operation of the fuel cell power module for a following second time period; and
e) repeating step b) to d) at the end of the second time period.

12. A method according to claim 7, wherein step (b) comprises one of measuring the power drawn, the power requested, the current drawn and the current requested by the load.

13. A method according to claim 11, wherein the time average in step b) is selected from the group consisting of a moving time average, a mean value and an endpoint-to-endpoint average.

14. A method as claimed in claim 11 including selecting the second time period to be the same as the first time period.

15. A method as claimed in claim 11, including varying the length of the first and second time periods.

16. A method of operating an electrochemical cell system having a fuel cell power module, an electric energy storage module and an adaptive energy management controller:
a) connecting the fuel cell power module through the adaptive energy management controller to the electric energy storage module, and connecting the electric energy storage module to a load, for supply of power to the load;
b) measuring a process parameter indicative of the power drawn by the load;
c) calculating and storing a time average value of the power drawn be the lad over a first pre-set time period;
d) using the stored time average value as an actual current draw request set-point signal to the adaptive energy management controller for regulating the operation of the fuel cell power module for a following second time period; and
e) at the end of the second time period repeating steps b), c) and d).

17. An electrochemical cell system having a fuel cell power module and an electric energy storage module, the fuel cell power module comprising a fuel cell stack, a balance-of plant unit for controllably connecting the fuel cell stack in fluid communication with at least one process fluid, an output of the fuel cell power module connectable to the electric energy storage module and an output of the electric energy storage module connectable to a load; the system further comprising:
an adaptive energy management controller connectable between the fuel cell power module and the electric energy storage module for regulating operation of the fuel cell power module, the adaptive energy management controller comprising
a measurement device for measuring a process parameter indicative of the power drawn by the load, and
a calculation and storage device for calculating and storing a time average value indicative of the power drawn over a first pre-set time period;
wherein the stored time average value is used as an actual current draw request set-point signal by the adaptive energy management controller for regulating the operation of the fuel cell power module for a second time period following the first time period.

18. The system as recited in claim 17, wherein the time average value is selected from the group consisting of a moving time average, a mean value and an endpoint-to-endpoint average.

19. The system as recited in claim 18, wherein the system further comprises a control unit for regulation of the fuel cell stack and the balance-of-plant unit.

20. The system as recited in claim 19, wherein the adaptive energy management controller comprises the control unit.
